(19) United States
(12) Patent Application Publication
(10) Pub. No.: US 2007/0141230 A1
(43) Pub. Date: Jun. 21, 2007

(54) Recovery of peptones

(76) Inventors: Darrell V. Chenault, Buffalo, MN (US); Harapanahallli S. Muralidhara, Plymouth, MN (US)

Correspondence Address: CARGILL, INCORPORATED, LAW/24, 15407 MCGINTY ROAD WEST, WAYZATA, MN, 55391, US

(21) Appl. No.: 10/560,859

(22) PCT Filed: Jun. 24, 2004
(86) PCT No.: PCT/US04/20829

§ 371 Date: Dec. 15, 2005

Related U.S. Application Data
(60) Provisional application No. 60/482,129, filed on Jun. 24, 2003.

(51) Int. Cl. A23J 1/00

(52) U.S. Cl. 426/656

(57) ABSTRACT

The present invention relates to an effective process for converting animal-derived protein-containing material into a peptone mixture. The process comprises a step involving alkaline hydrolysis of the protein-containing material. The hydrolysis step can be rapid and typically requires only a low concentration of alkaline material. The overall conversion process can produce a high yield of small peptones and other peptones. The resulting peptones may be further separated, purified or otherwise processed to provide desired properties such as molecular weight distribution, water solubility, dry color and dry flowability.

### CROSS REFERENCE TO RELATED APPLICATION

The subject matter of this application is a continuation-in-part application of prior application Ser. No. 60/482,129, filed on Jun. 24, 2003.

### FIELD OF THE INVENTION

The invention relates to the recovery of peptones from animal-derived protein-containing materials. More particularly, it relates to the recovery of peptones from poultry waste materials, such as turkey waste materials, using alkaline hydrolysis. The invention also relates more specifically to the peptones recovered from the keratin-containing materials, such as feathers.

### BACKGROUND

The turkey industry provides billions of pounds of food in the United States each year. The industry yield further includes approximately 25% waste turkey material not usable for traditional food. Such waste materials traditionally include feathers, feet, heads, beaks, blood, guts, viscera, and other waste material from the turkey. This material includes a significant protein component, including keratin.

Keratin is a fibrous protein found in turkey feathers, chicken feathers, bristles, hair, hooves, fingernails, horns, wool and similar sources. An important source of keratin is found in the poultry industry, involving feathers from rendered turkeys and chickens. Keratin, similar to other proteins, comprises polymers of amino acid monomers (amino acid monomers are also referred to herein as amino acid mers) which are insoluble in water at ambient conditions. In view of the amino acid content, it has been attractive to develop methods to hydrolyze keratin into digestible or other useable peptones. Particularly useful peptones include small peptones which include amino acid trimers, amino acid dimers, and amino acid monomers. Small peptones have particularly important industrial applications as food supplements, cosmetics, and pharmaceuticals.

While the industry has developed methods to digest these proteins to be used in feed, fertilizer, cosmetics, and even food additives, current methods for processing turkey waste material are generally inefficient, slow, inflexible, or otherwise unattractive. Techniques to hydrolyze keratin into a nutritional supplement for feed typically include grinding and boiling feathers to create a product called feathermeal. Alternate techniques include hydrolysis into digestible polypeptides using an acid, an enzyme, or a base. Other alternate techniques include hydrolysis into digestible polypeptides using an electrical discharge, fermentation, or bacteria driven activity.

The shortcomings of methods currently available include the general inability to provide mixtures with sufficient solubility, dry flowability, dry color, desired molecular weight distributions or undamaged amino acid components. For example, see, U.S. Pat. No. 5,049,279.

There remains a significant need for an improved technique for processing animal-derived protein-containing waste materials, including keratin containing materials, into peptones. In addition, there is a need to create peptones which have one or more superior properties for industrial applications—properties such as improved whiteness, flowability, solubility, and free amino nitrogen content.

### SUMMARY OF THE INVENTION

The present invention relates to an effective process for converting animal-derived protein-containing material into a peptone mixture. The process comprises a step involving alkaline hydrolysis of the protein-containing material. The hydrolysis step can be rapid and typically requires only a low concentration of alkaline material. The overall conversion process can produce a high yield of small peptones and other peptones. The resulting peptones may be further separated, purified or otherwise processed to provide desired properties such as molecular weight distribution, water solubility, dry color and dry flowability.

A method for processing a protein-containing material and/or making peptones in accordance with one embodiment of the invention comprises the following step: (1) contacting reactants and creating a reaction mix for a period of less than approximately six hours, wherein the reactants comprise an animal-derived protein-containing material and an alkaline material, wherein at least some of the protein is hydrolyzed into a mixture of peptones, and wherein the mixture of peptones has a molecular weight distribution such that at least a portion of the peptones have no more than three amino acid mers. The pH of the reaction mix may be approximately 8 or higher and the temperature of the reaction mix may be above about 90 degrees C. The protein-containing material may comprise feathers, for example poultry feather such as turkey feathers. Alternately, the protein-containing material may comprise offal. Of course, a mix of keratin-containing materials may be used. The alkaline material may comprise sodium hydroxide. The method may be carried out to produce a mixture of peptones having solubility in water of at least about 0.01915 gm/ml.

In another embodiment, the invention relates to a method for processing a protein-containing material, such as a turkey waste material, comprising the following steps: (1) contacting reactants and creating a reaction mix; wherein the reactants comprise a animal-derived protein-containing material and an alkaline material; and wherein a reaction product is obtained which comprises peptones; and (2) purifying the reaction product to obtain a mixture of peptones for which substantially all of the peptones have a molecular weight of at least 1,000 Daltons. More specifically, the mixture of peptones may have a particular molecular weight distribution with the molecular weight distribution being affected by controlling the reaction parameters. Further, the reaction mixture may be separated using filters. The pH of the reaction mix may be approximately 8 or higher and the temperature of the reaction mix may be above about 90 degrees C. The reactants may be contacted for a period of less than approximately six hours. The protein-containing material may comprise feathers, for example poultry feather such as turkey feathers. Alternately, the protein-containing material may comprise offal. Of course, a mix of protein-containing materials may be used. The alkaline material may comprise sodium hydroxide.

A method for processing a protein-containing material in accordance with another embodiment of the invention comprises the following steps: (1) contacting reactants and creating a reaction mix, wherein the reactants comprise an animal-derived protein-containing material and an alkaline material, wherein at least some of the protein is hydrolyzed into a mixture of peptones; (2) separating at least some of the peptones; and (3) drying the separated peptones. This method may be performed to produce dried peptones may having a dry whiteness of L exceeding 75, excellent dry flowability, or high free amino nitrogen content.

The invention further provides a method for obtaining small peptones comprising the following steps: (1) providing a quantity of feathers; (2) contacting the feathers with an alkaline solution to produce a reaction mix; (3) holding the feathers in the reaction mix for a period of time less then about six hours to produce small peptones from the feathers; and (4) purifying the small peptones. The pH of the reaction mix may be approximately 8 or higher and the temperature of the reaction mix may be above about 90 degrees C. The feathers may comprise poultry feathers such as turkey feathers. The alkaline material may comprise sodium hydroxide. The step of holding the feathers in the reaction mix may be for a sufficient time to produce small peptones produced that are monomers, dimers and trimers of amino acids from feathers. Further, the step of purifying the small peptones may include purifying cystine, cysteine, lysine, glutamic acid, or phenylalanine from the reaction mix.

In accordance with another embodiment of the invention, a method for obtaining a peptone concentrate is provided comprising the following steps: (1) providing a quantity of turkey waste material; (2) mechanically breaking the turkey waste material into smaller pieces; (3) contacting the resultant turkey waste material pieces with an alkaline solution to produce a reaction mix, wherein the temperature of the reaction mix is above about 90 degrees C.; (4) holding the turkey waste material pieces in the reaction mix for a period of time sufficient to produce peptones; wherein a predominance of the peptones have a molecular weight less than about a pre-determined number of Daltons; (5) cooling the reaction mix; (6) neutralizing the reaction mix; (7) pre-filtering the reaction mix to remove large impurities; (8) filtering the remaining reaction mix to obtain a peptone concentrate for which substantially all of the peptones have a molecular weight of at least about a pre-selected number of Daltons; (9) spray drying the peptone concentrate; and (10) collecting the peptone concentrate. The turkey waste material may comprise feathers, offal, or combinations thereof.

Using the methods of the present invention, a mixture of peptones may be produced having a dry whiteness of L exceeding about 55, a dry flowability angle less than about 60 degrees without tap, and a solubility in water of at least about 0.01915 gm/ml.

An additional embodiment of the invention is an ingredient, and the manufacture thereof, for use in pet foods which includes a peptone concentrate produced by the methods described herein.

A further embodiment is a fertilizer (fertilizer additive), and the manufacture thereof, including a peptone concentrate produced by the methods described herein. This fertilizer (or fertilizer additive) may be manufacture using potassium hydroxide as the alkaline material and phosphoric acid as the neutralizing material.

Unless otherwise defined, all technical and scientific terms used herein have the same meaning as commonly understood by one of ordinary skill in the art to which this invention belongs. In addition, the materials, methods, and examples used herein are illustrative only and not intended to be limiting. Details of one or more embodiments of the invention are set forth in the accompanying tables, drawings, and the description below. Other features, objects, and advantages of the invention will be apparent from the description, tables, and drawings, and from the claims.

### BRIEF DESCRIPTION OF THE DRAWINGS

FIG. 1 illustrates a flow diagram of an embodiment for converting protein-containing materials into peptones.

### DETAILED DESCRIPTION

The invention provides a process for converting an animal-derived protein-containing material, such as poultry offal or feathers, into a peptone mixture comprising a substantial amount of peptones. More specifically, the invention may be used to convert a keratin-containing material, such as turkey feathers, into a peptone mixture. As used herein, a peptone is a molecule comprising a one or more amino acid mers, and typically having a peptide bond between adjacent amino acid mers. Peptones include at least one amino acid mer, but substantially fewer amino acid mers than the protein from which the peptone was derived. In particular, as used herein, a peptone typically has a molecular weight of less than about 20,000 Daltons, but at time may be larger. A given mixture of peptones can include a broad range of peptone sizes from amino acid monomers, dimers and trimers to substantial peptide fragments. At times it is desirable to select for a particular peptone size distribution for a given peptone mixture.

The methods of the present invention may be used to produce a peptone mixture having specific desired traits. For example, the methods may be used to impact properties such as dry color, solubility in water, dry flowability, and molecular weight distribution.

The methods include a step involving alkaline hydrolysis of the protein-containing material, such as turkey waste material. The hydrolysis step may be rapid and requires only a low concentration of alkaline material. In certain preferred embodiments the invention utilizes an alkaline hydrolysis process to digest turkey waste material into a peptone mixture. In certain preferred embodiments the hydrolysis requires only a small concentration of alkaline material for periods nominally two hours or less, but at times this time may be for six hours or more. Generally, the alkaline material has a pH of about 8 or higher. Suitable materials include sodium hydroxide, calcium hydroxide, potassium hydroxide, strontium hydroxide, magnesium hydroxide, lithium hydroxide, and other similar alkalis. The alkali may be concentrated, may be dilute, and may be in aqueous solution.

In the present invention, the animal-derived protein-containing material is typically waste material. For example, poultry waste starting materials typically include the materials remaining after a whole animal is rendered—after the portion used for meat products has been removed. The remaining waste materials are typically feathers and offal. Examples of offal include feet, heads, beaks, blood, guts, viscera, and other waste materials. The specific assortment of waste materials is not critical. For example, the waste materials could include all or some of the materials listed above, or may include part of the portion traditionally processed for meat products. Examples of suitable starting keratin-containing materials include poultry feathers (such as turkey feathers and chicken feathers), bristles, hair, hooves, fingernails, horns, and wool. Feathers for use with the present invention may be in virtually any form. The feathers may be whole, they may be broken into pieces, or may be combinations of whole and broken feathers. The feathers may contain impurities such as dirt, other foreign matter, or non-feather material from the bird. While some of the embodiments of the present invention are largely exemplified with turkey feathers, the invention may be used with any keratin-containing materials.

The starting material, for example, feathers, is pretreated for the alkaline hydrolysis by grinding, chopping, or comminuting into smaller pieces. The smaller pieces then undergo hydrolysis with an alkaline material, which digests the smaller pieces forming peptones. The peptones can be optionally processed with pre-filtering, carbon treatment, membrane filtering, and spray drying. The separated product can contain a high density of peptones with molecular weight in a pre-determined range.

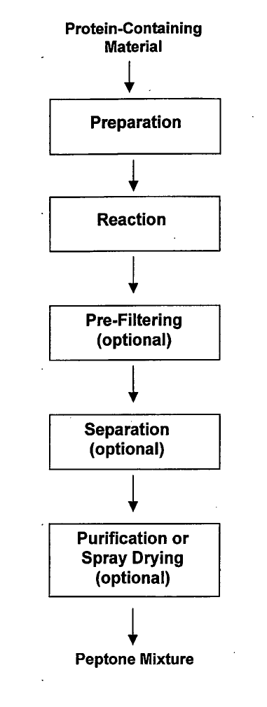

A typical overall process for an embodiment involving alkaline hydrolysis of protein-containing materials is shown schematically in FIG. 1. As can be seen, the process for this embodiment involves up to five stages: Preparation, Reaction, Pre-Filtering (optional); Separation (optional), Purification or Spray Drying (optional). A brief summary of each stage is given below.

### Preparation Stage

A wide range of animal-derived protein-containing materials such as turkey waste materials may be provided from a number of sources. Typical sources include poultry processing plants. If the waste material is feathers and offal, the ratio of the amount of feathers to the amount of offal is not critical. For example the waste material may include only feathers, may include only offal, or may include combinations thereof. In addition, if the waste material includes both feathers and offal, the feathers and offal may be processed separately or in combination. The waste material, as received, may be washed to remove dirt and other foreign matter. Effective washing procedures are well known to those skilled in the art. The waste material, regardless of whether washed, is then ground, comminuted, chopped, or otherwise broken into smaller pieces in preparation for the reaction stage. Although the specific equipment for creating the smaller pieces is not critical, illustrative equipment includes grinders, choppers, shredders, and ball mills. In addition, although the precise resultant size of the smaller pieces is not critical, the reaction process has been found to progress more effectively if the smaller pieces of feathers have a average maximum dimension of approximately 5 mm to 25 mm, and if the smaller pieces of offal have an average maximum dimension of approximately 2 mm to 10 mm.

### Reaction Stage

The waste material pieces resulting from the preparation stage are placed in a chemical reactor or other suitable vessel. An alkaline material, often in the form of an alkaline solution, is added to the reactor and allowed to mix with the waste material. The sequencing of the addition of the alkaline solution and the addition of the waste materials is not critical. The mixing of the alkaline solution and the waste materials is typically enhanced by stirring, shaking, or other suitable enhancing technique. Effective mixing techniques are well known to those skilled in the art. The waste material and the alkaline solution are allowed to react for sufficient time to allow the protein of the waste materials to be digested into a mixture having a substantially quantity of peptones. In one embodiment, the molecular weight distribution of the mixture is such that the mixture comprises a portion of amino acid trimers, amino acid dimmers, and amino acid monomers. In another embodiment insufficiently hydrolyzed material may be separated from the peptone-containing mixture and returned to the reactor for further treatment.

The degree of reaction may be controlled by varying reaction conditions. In particular, it can be controlled such that the resultant peptone mixture has a pre-determined upper level in molecular weight. Thus, it can be controlled such that a predominance of peptones in the mixture has a molecular weight below the pre-determined upper level. For example, in one embodiment, at least about 75% of the peptones have a molecular weight less than a pre-determined level of approximately 6000 Daltons.

The alkaline material is typically an aqueous solution of an alkali which has a pH exceeding about 8. Examples of suitable alkalis include sodium hydroxide, calcium hydroxide, potassium hydroxide, strontium hydroxide, magnesium hydroxide, lithium hydroxide, and other similar alkalis. For illustrative purposes, the method is described using sodium hydroxide. The concentration of an effective sodium hydroxide aqueous solution can range from about 0.1 wgt % to about 2.0 wgt %; or from about 0.25 wgt % to about 0.75 wgt %. About 0.5 wgt % is typical. Although the alkaline solution may be prepared by virtually any technique known to those skilled in the art, one method involves mixing in-line 50 wgt % sodium hydroxide aqueous solution with water prior to feeding the alkaline solution into the reactor.

The reaction typically occurs at a temperature exceeding about 90 or 95 deg C. Occurring at about 98 deg C. is typical. Other suitable temperatures may be used if the reaction progresses at that temperature. Of course the temperature should not exceed the boiling point of the reaction mix. In addition, the reaction typically occurs at a pressure of about 0 psig to about 10 or 15 psig. Although the reaction typically occurs at 0 psig to 15 psig, it should be recognized that it may also occur at lower pressures, such as at vacuum, and at higher pressures.

The reaction time to produce a desired mixture of peptones is a function of the particular alkaline material used, and its concentration. In addition, the reaction time is a function of the temperature of the reaction and the pressure of the reaction. The reaction time can range from less than one hour to several days, with a time of less than six hours preferred and less than three hours more preferred. For an embodiment wherein the alkaline solution is about 0.5 wgt percent of sodium hydroxide, the temperature is about 98 degrees C., and the pressure is between 0 and 10 psig, the reaction time is about one to three hours.

Using the embodiment described above, a mixture of peptones comprising amino acid trimers, amino acid dimers, and amino acid monomers, and other small peptones is produced. More specifically, a typical pre-determined upper level of molecular weight for the peptones is about 6,000 Daltons. Alternately, the pre-determined upper level may be varied by changing reaction parameters which affect the degree of hydrolysis. For example, for shorter reaction times, the pre-determined upper level may be higher—using a sufficiently short reaction time, the pre-determined upper level may be about 20,000 Daltons. Similarly, for longer reaction times, the pre-determined upper level may be lower—using a sufficiently long reaction time, the pre-determined upper level may be about 2,000 Daltons.

After the reaction described above (typically at about 98 degrees C.), the mixture of reaction product and remaining reactants is allowed to cool, to about 40 to about 60 degrees C. with approximately 50 degrees C. being typical. Alternate temperature ranges for cooling may be used as suitable. Either before or after cooling, the mixture is neutralized by adding a neutralizing material (or otherwise referred to as neutralizing agent). To decrease degradation of the peptones due to excessive heat it may be desirable to cool the mixture before neutralization. Suitable neutralizing agents include mineral acids such hydrochloric acid, sulphuric acid, nitric acid, phosphoric acid, and other similar materials having a low pH. Sufficient neutralizing agent is added until the pH of the mixture is reduced to about 6.0 to 8.0; or about 6.5 to about 7.5. Reducing the pH to about 7.0 is typical.

Thus, during the reaction stage, a pre-determined upper level for the molecular weight of the resultant peptones may be set by controlling the amount of hydrolysis of the starting material.

### Pre-Filtering Stage

The pre-filtering stage is an optional stage to remove insoluble materials such as large impurities and may occur before or after neutralization of the reaction product. The peptone reaction product resulting from the reaction stage is at least partially soluble in water. Typical pre-filtering treatments include centrifuging, filtering, and other similar techniques. After treatment, the remaining product is may be passed through filters or other separation devices to remove other large material that was not removed by the treatment. Typical pre-filtering involves successive passage through filters of 5.0 microns, 1.0 microns, and 0.2 microns. It should be recognized that the specific filters sizes are not critical, and other filter sizes mat be used.

Large impurities removed by pre-filtering include impurities that may have entered the process from any source. The pre-filtering stage generally removes large impurities, which are typically insoluble and typically significantly larger than the maximum peptone size in the mixture. Examples include: non-animal derived items mixed with the original waste material, impurities occurring from the processing equipment and from the processing itself, and other impurities from any source. Typical large insoluble impurities include items such as plastic chips, wood chips, particles from a machine, metal, and other extraneous materials.

Un-hydrolyzed protein-containing materials, proteins or large protein fragments may be removed in the pre-filtering stage. In some cases these removed materials may be returned to the reactor for further treatment to improve yield of the overall process.

To improve the purity, smell, or taste of the product, the remaining product may be treated with activated carbon to remove organic impurities including odoriferous compounds.

Specific techniques used for the pre-filtration are not critical. Methods well known to those skilled in the art can be used. Although centrifuging, filtering, and carbon treatment are processes specifically mentioned herein, other suitable techniques may be used.

### Separation Stage

The separation stage is an optional stage where the various constituents of the peptide mixture may be separated by molecular weight. More particularly, as described above, the mixture may include peptones having molecular weights above and below a desired molecular weight cutoff. In a preferred embodiment the separation stage allows the selective removal of low molecular weight peptones, and creates a mixture having a high concentration of peptones having molecular weight in a pre-determined range.

In a specific embodiment, the solution is passed through a membrane filter, wherein substantially all of the peptones having a molecular weight over a threshold of N Daltons are captured in the concentrate. Although the threshold N is pre-selected and arbitrary, a typical preferred level is 1000 Daltons. To create such a 1000 Dalton threshold concentrate, a membrane having pores of about 20 to 30 Angstroms may be used. However, other pore sizes may be used to create various thresholds. For example, typical pore sizes may range from about 5 Angstroms or lower, to 10 Angstroms, to 50 Angstroms, or to 500 Angstroms or higher.

This separation results in the formation of a primarily higher molecular weight peptone containing concentrate (the portion which does not pass through the membrane filter) and a primarily lower molecular weight peptone containing permeate (the portion which passes through the membrane filter and is typically rich in small peptones, including amino acid monomers, dimers, and trimers).

Both the concentrate and permeate have a selectable predominant molecular weight distribution. In the case of the concentrate, the lower level of the range is pre-selected by controlling the pore size of the membrane filter while the upper level is pre-determined by controlling the degree of digestion in the reaction stage. A typical pre-determined molecular weight range for this concentrate is 1000 Daltons to 6000 Daltons, however upper levels greater than 100,000 Daltons and lower levels less than 500 Daltons are readily achievable. In the case of the permeate, the upper level is pre-determined by controlling the pore size of the membrane filter and the lower level consists of amino acid monomers which typically have molecular weights between 75 and 205 Daltons

In embodiments where the primary product is the permeate peptones, it may be desirable to return the concentrate to the reactor for further treatment as a method of increasing yields.

### Purification and Spray Driving Stage

Either or both purification and spray drying may be performed depending on the product desired. Depending on the desired product, a peptone-containing solution resulting from the reaction stage, the pre-filtration stage, or the separation stage (either or both concentrate and permeate) may be spray dried. In the alternative, a peptone-containing solution resulting from the reaction stage, the pre-filtration stage, or the separation stage (both concentrate and permeate) may be further concentrated by crystallization, precipitation or other methods know in the art.

In the case of the permeate mixture of small peptones from the separation stage, it may be desirable to further purify one or more peptone constituents by techniques such as electrodialysis, electrodeionization (EDI), or other techniques known in the art. For example, the permeate mixture of small peptones can be purified by electrodialysis to provide individual amino acids. Typically, cystine monomers, cysteine monomers, glutamic acid monomers, phenylalanine monomers, lysine monomers, and other amino acid monomers can be individually separated from the permeate mixture.

Typical applications for the small peptones of the removed permeate include: food additives, pharmaceutical substances, cosmetics, and shampoo. Additionally, a product derived from either a permeate or a concentrate of the present invention where the substantially all the peptones have a molecular weight less than 10,000 Daltons is often desirable for pet foods.

Spray drying is done using standard techniques, known to those skilled in the art, to produce a dry peptone product. The percentage of peptones in the dry peptone product varies with the amount of non-peptone impurities allowed to pass through the filtering and purification processes. Although the pre-filters, the activated carbon, and the filter membranes can eliminate a large quantity of non-peptone impurities, other purification techniques may be used to reduce the amount of non-peptone impurities. Such other purification techniques are well known to those skilled in the art.

The resultant mixture of peptones can display excellent properties. For example, the mixture of peptones can display a solubility in water of at least 0.01915 gm/ml [THE PROVISIONAL HAD AT LEAST 0.01915 GM/ML—WHICH IS CORRECT?]. The solubility is measured using the CRC method as described in the CRC Handbook of Chemistry and Physics (83^{rd} edition—hereinafter called the CRC Handbook). In addition, the mixture of peptones can display a dry whiteness of L exceeding 55. Dry whiteness is the whiteness of a material when it is dry. Dry whiteness can be measured using the L,a,b scale on a Hunter Lab colorimeter Color Quest XE. The value of L measures the whiteness itself. For example, L=0 represents absolute black and L=100 represents absolute white. The values of a and b reflect different shades of color. It should be realized that the value of L (the Whiteness itself) is most important for the invention, and that the values of a and b can vary for a particular value of L. It should also be recognized that other standard equipment (other than the Hunter Lab colorimeter) can be used to measure whiteness. Further, the mixture of peptones can display a dry flowability angle which is less than 60 degrees without tap. Dry flowability characterizes the rate or ease in which dry materials such as powders, granules, or solid particles move during a period of time when poured, pumped, or physically transferred from one container to another. Dry materials such as powders, granules, or solid particles have physical characteristics such as particle size, shape, angularity, size variability and hardness will affect the flow properties of that dry material. There are also external factors such as humidity, temperature, and electrostatic charge that can affect the flow of the dry material. Dry flowability can be measured using angle of repose techniques or other standard techniques. Properties such as these are particularly useful for a variety of applications such as pet food, fertilizer, biological culture media, fermentation media, fire retardant, and shampoo applications.

In embodiments where the peptones are to be used in fertilizer applications it is particularly advantageous to use potassium hydroxide as the alkaline material and phosphoric acid as the neutralizing material as the residual potassium and phosphorus remaining in the peptone mixture are useful ingredients in fertilizer applications.

The invention is further illustrated by the following examples. The examples are intended to illustrate the spirit of the invention and certain embodiments of the invention, not to restrict the invention. One of ordinary skill in the art, after reading the description of the invention provided herein, will be able to envision additional embodiments. It is the intent of the inventors that all such embodiments are included in the invention.

### EXAMPLES

### Example 0—(A Control)

Five pounds of turkey feathers were provided from a plant in California, Mo. for testing. Three batches of feathers, weighing about 10 grams per batch, were analyzed to determine the total amino acid content of the feathers using an Beckman Amino Acid Analyzer. The analysis indicated the batches respectively contained 947,668.8 ppm amino acid content, 999,286.8 ppm amino acid content, and 863,446.2 ppm amino acid content. The amino acid content average for the three batches was 936,800.6 ppm amino acid or equivalently 93.68 wgt % of the feather material (on average) was made up of amino acids.

The results of example 0 are summarized in Tables 1A & 1B.

### Example 1

A quantity of feathers as received from the plant in California, Mo. was washed to remove dirt and other foreign matter. The washed feathers were dried. After washing and drying, a portion of the smaller feathers were ground into smaller pieces having an average maximum dimension of approximately 25 mm. The grinding was performed with standard chopping equipment. (Larger quills were excluded from the grinding because they did not grind well with the particular equipment used.) The resultant quantity of ground feathers weighed 10.99 grams.

The ground feathers were placed into a pressurized Parr reactor. The Parr reactor comprises a closed 1000 ml stainless steel vessel having a stainless steel mixer. The reactor has a digital control panel that displays and controls the temperature inside the reactor and the speed of the mixer. Reaction time, temperature, and pressure were monitored during the experiment. A digestion solution, 450 ml of 0.5 wgt % aqueous solution of sodium hydroxide, was added. The digestion solution was mixed with the ground feathers, and reacted with the feathers for 30 minutes at 98° C. (+/−2° C.) at 0-10 psig. The pH of the reaction medium was 13 to 14. Visual inspection indicated brownish haze in liquid, and the feathers were still partially intact. The reaction was continued at the same conditions for 30 minutes longer, and visual inspection indicated complete digestion.

After the reaction, the mixture of the reaction product and the remaining reactants was cooled to 58° C. using a circulating cooling bath with ethylene glycol. After the cooling, 30 grams of a 10 wgt % aqueous solution of hydrochloric acid was added to neutralize the mixture by reducing its pH to about 7.0.

The reaction products and remaining reactants were centrifuged using a Beckman centrifuger Model J2-21 and filtered through #42 Whatman filter paper under vacuum to remove insoluble materials. The remaining materials were treated with activated carbon using an in bed vacuum filtration technique to remove organic impurities including odoriferous compounds and color bodies. After treatment with activated carbon, the remaining materials were spray dried using a Buchi mini spray dryer Model B-191 to separate the peptones from remaining impurities. The final peptone material was white in color. Its dry whiteness was L=81.59. Its solubility in water was 0.01915 gm/ml. In addition, the final peptone material contained 614,163.8 ppm of peptones based on the total starting material. The starting material contained (on average) 936,800.6 ppm amino acid content; hence the yield of peptones was (614,163.8)/(936,800.6) or 65.55%.

The spray dried mixture of peptones was analyzed using the previously mentioned Beckman amino acid analyzer to determine its total amino acid content. The mixture was also analyzed using the HPLC size exclusion technique to determine the molecular weight distribution of amino acid trimers, amino acid dimers, amino acid monomers, other small peptones and other peptones. The mixture was found to have approximately 10% of the peptones exceeding 100,000 Daltons, 10% between 6000 and 100,000 Daltons, 75% between 1000 and 6000 Daltons, and 5% less than 1000 Daltons. This indicates to those skilled in the art that the mixture contains a substantial amount of small peptones, including at least a portion of amino acid trimers, dimers, and monomers. In addition, the specific amount present for particular amino acid monomers could have been measured using the HPLC size exclusion technique or other standard technique.

The whiteness of the dry mixture of peptones was measured with the Hunterlab calorimeter as described earlier. The solubility in water of the dry mixture was measured using the CRC handbook technique. Finally, the specific dry flowability of the peptones could have been measured with standard angle of repose technique, and free amino nitrogen content could have been measured using a Beckman Amino Acid Analyzer. The results of example 1 are summarized in Tables 1A & 1B.

### Example 2

Example 2 was conducted in essentially the same manner as example 1. The weight of the ground feathers was 44 grams. The digestion solution was 450 ml of 0.5 wgt % aqueous solution of sodium hydroxide. The pH of the digestion reaction medium was 13 to 14. The temperature for the hydrolysis digestion reaction was about 70 deg C., the digestion time was 1 hours, and the pressure for the digestion reaction was 0-10 psig. Visual inspection at the end of the digestion reaction showed complete digestion. Other test parameters were essentially the same as those described for example 1.

The final peptone material was white in color. In addition, the peptones had a similar appearance and flowability to those of example 1. Finally, the final peptone material contained 133,825.90 ppm of peptones based on the total starting material. The starting material contained (on average) 936,800.6 ppm amino acid content; hence the yield of small peptones was (133,825.90)/(936,800.6) or 14.3%.

The results of example 2 are summarized in Tables 1A & 1B.

### Example 3

Example 3 was conducted in essentially the same manner as example 1. The weight of the ground feathers was 44 grams. The digestion solution was 750 ml of 0.5 wgt % aqueous solution of sodium hydroxide. The pH of the digestion reaction medium was about 11-12. The temperature for the hydrolysis digestion reaction was about 100 deg C., the digestion time was 3 hours, and the pressure for the digestion reaction was 0-10 psig. Visual inspection at the end of the digestion reaction showed complete digestion. Other test parameters were essentially the same as those described for example 1.

The final peptone material was white in color. In addition, the peptones had a similar appearance and flowability to those of example 1. The actual peptone content was not measured.

The results of example 3 are summarized in Tables 1A & 1B.

### Example 4

Example 4 was conducted in essentially the same manner as example 1. The weight of the ground feathers was 44 grams. The digestion solution was 800 ml of 0.5 wgt % aqueous solution of sodium hydroxide. The pH of the digestion reaction medium was about 12-13. The temperature for the hydrolysis digestion reaction was about 98° C., the digestion time was 3 hours, and the pressure for the digestion reaction was 0-10 psig. Visual inspection at the end of the digestion reaction showed complete digestion. Other test parameters were essentially the same as those described for example 1.

The final peptone material was white in color. In addition, the peptones had a similar appearance and flowability to those of example 1. The actual peptone content was not measured.

The results of example 4 are summarized in Tables 1A & 1B.

### Example 5

Example 5 was conducted in essentially the same manner as example 1. The weight of the ground feathers was 44 grams. The digestion solution was 450 ml of 0.5 wgt % aqueous solution of sodium hydroxide. The pH of the digestion reaction medium was about 13-14. The temperature for the hydrolysis digestion reaction was about 50° C., the digestion time was 10 hours, and the pressure for the digestion reaction was 0-10 psig. Visual inspection at the end of the digestion reaction showed complete digestion. Other test parameters were essentially the same as those described for example 1.

The final peptone material was white in color. In addition, the peptones had a similar appearance and flowability to those of example 1. Finally, the final peptone material contained 107,323.97 ppm of peptones based on the total starting material. The starting material contained (on average) 936,800.6 ppm amino acid content; hence the yield of small peptones was (101,323.97)/(936,800.6) or 10.8%.

The results of example 5 are summarized in Tables 1A & 1B below.

TABLE 1A

| | Amount | | Digestion | | | | | | | |
|---|---|---|---|---|---|---|---|---|---|---|
| | of Turkey | | Solution | | Digestion | Digestion | Digestion | Digestion | | Total Amino |
| | Feathers | Hydrolysis | % | ml | Solution | Temp | Time | Pressure | No. of | Acid Content |
| Ex. | grams | Process | NaOH | NaOH | pH | deg C. | hours | psig | Batches | ppm |
| 0 | Control | None | None | None | N/A | N/A | N/A | N/A | 3 | 936,800.6 |
| 1 | 10.09 | Alkaline | 0.5 | 450 | 13-14 | 98 | 1 | 0-10 | 1 | 614,163.8 |
| 2 | 44 | Alkaline | 0.5 | 450 | 13-14 | 70 | 1 | 0-10 | 1 | 133,825.90 |
| 3 | 44 | Alkaline | 0.5 | 750 | 11-12 | 100 | 3 | 0-10 | 1 | — |
| 4 | 44 | Alkaline | 0.5 | 800 | 12-13 | 98 | 3 | 0-10 | 1 | — |
| 5 | 44 | Alkaline | 0.5 | 450 | 13-14 | 50 | 10 | 0-10 | 1 | 107,323.97 |

TABLE 1B

| | | Characteristics of Dried Mixture of Peptones | |
|---|---|---|---|
| | Peptone Yield | Whiteness | Aqueous Solubility |
| Ex. | Percent | L, a, b scale_ Units | _g/ml_ Units |
| 0 | N/A | N/A | N/A |
| 1 | 65.55 | L = 81.59 | 0.1915/10 |
| | | (a = −1.52, b = 11.64) | |
| 2 | 14.3 | — | — |
| 3 | — | — | — |
| 4 | — | — | — |
| 5 | 10.8 | — | — |

### Example 6

A quantity of turkey feathers was received from a plant in Springdale, Ark. A portion of the feathers were ground into smaller pieces having an average maximum dimension of approximately 25 mm. The grinding was performed with standard chopping/grinding equipment. The resultant quantity of ground feathers weighed 6.0 pounds.

The ground turkey feathers were placed into a reactor. The reactor comprised an open-top 50 gallon stainless steel vessel having a stainless steel mixer. The reactor had a digital control panel that displays and controls temperature inside the reactor and speed of the mixer. Reaction time, temperature, and pressure were monitored during the process. A digestion solution, 460 grams of sodium hydroxide in 0.5 wgt % aqueous solution, was added. The digestion solution was mixed with the ground turkey feathers, and reacted with the feathers for (1 hour at 98° C. (+/−2° C.) at atmospheric pressure. The pH of the reaction medium was 12 to 13. Visual inspection indicated a brown liquid, and the feathers appeared digested.

After the reaction, the mixture of the reaction product and the remaining reactants was cooled to 50° C. using a circulating cooling bath with ethylene glycol. After the cooling, 680 ml of hydrochloric acid in a 10 wgt % aqueous solution were added to neutralize the mixture by reducing its pH to about 7.0.

The reaction products and remaining reactants were filtered through a sand filter to remove insoluble materials. The remaining materials were passed through three consecutive filters; the first filter had a mesh size of 5.0 microns; the second filter had a mesh size of 1.0 micron; and the third filter had a mesh size of 0.2 microns.

After filtering, the remaining material was flowed through a membrane filter having a molecular weight cutoff of a pre-selected number of Daltons. In particular, the pore size was chosen to capture as concentrate peptones having a pre-selected molecular weight of about 1,000 Daltons. The membrane filter separated the flow into a concentrate mixture (the portion which did not pass through the membrane filter) and a permeate mixture (the portion which did pass through the membrane filter).

The permeate mixture was removed from the example 6 process.

The concentrate mixture was spray dried using a Niro Atomizer Portable Spray Dryer drying unit to remove remaining water. The spray dried concentrate was a dried peptone concentrate of 0.784 pounds which was off-white in color.

The dried peptone concentrate of example 6 was placed aside and later combined and mixed with the dried peptone concentrate of example 7. The combined and mixed concentrates are discussed further in example 8.

Results of example 6 are summarized in Tables 2A & 2B.

### Example 7

A second quantity of turkey feathers was received from the plant in Springdale, Ark. and processed in essentially the same manner as example 6.

Substantive differences from example 6 consist of the following: a) After the initial grinding, the resultant quantity of ground feathers weighed 9.46 pounds. b) The spray dried concentrate was a dried peptone concentrate of 1.01 pounds. As described for example 6, the example 7 dried peptone concentrate was also off-white in color.

The dried peptone concentrate of example 7 was combined and mixed with the dried peptone concentrate of example 6. The combined and mixed concentrates are discussed further in example 8.

Results of example 7 are summarized in Tables 2A & 2B.

### Example 8

The dried peptone concentrates of Example 6 and Example 7 were collectively analyzed as Example 8. The two concentrates were thoroughly mixed by stirring to form the dried peptone concentrate of Example 8.

The dried peptone concentrate of example 8 was off-white in color. Its dry whiteness was L=60.01. Its solubility in water was 0.01915 gm/ml. Its dry flowability was 50-55 degrees without tap.

The whiteness of the dry concentrate was measured with the Hunter Lab colorimeter as described earlier. The solubility in water was measured using the CRC handbook technique described earlier. Finally, the dry flowability was measured with the standard angle of repose technique described earlier.

A chemical analysis of the dry concentrate of Example 8 indicated the following composition: peptones—84%; moisture—2%; fat—6%; ash—8%; total carbohydrate—0.1%; calcium—1340 ppm; magnesium—96.8 ppm; phosphorus—321 ppm; potassium—515 ppm; other materials—trace amounts which were not measured.

The peptones, moisture, fat, and ash were measured by methods described in Official Methods of Analysis of AOAC International (2002) 17th edition. (peptones—968.06 and 992.15; moisture—925.09 and 926.08; fat—922.06 and 954.02; ash—923.03). Total carbohydrate was measured by methods described in the Composition of Foods—Agriculture Handbook No. 8, US Department of Agriculture, pp 164-165, 1975. Calcium, magnesium, phosphorus, and potassium was measured by methods described in ICP EMISSION SPECTROMETRY: Official Methods of Analysis of AOAC INTERNATIONAL, (2000) 17 th ED., AOAC INTERNATIONAL Gaithersburg, Md., USA, Official Methods 984.27, 985.01. (Modified), and Inductively Coupled Plasma-Atomic Emission Spectrometry Analysis of Biological Materials and Soils for Major, Trace, and Ultra-Trace Elements, Applied Spectroscopy, 23:1-29 (1978). (Modified).

The dry concentrate was also analyzed using the HPLC size exclusion technique to determine the molecular weight distribution of peptones. The mixture was found to have approximately virtually no peptones exceeding 100,000 Daltons, 25% between 6000 and 100,000 Daltons, 75% between 1000 and 6000 Daltons, and virtually none less than 1000 Daltons. As can be seen, substantially all the peptones of the dry concentrate have a molecular weight of at least 1,000 Daltons. In addition, a predominance the peptones have a molecular weight in the range of 1,000 Daltons to 6,000 Daltons. In particular, about 75% of the peptones have a molecular weight in the range of 1,000 Daltons to 6,000 Daltons.

Results of example 8 are summarized as collective results for Examples 6 & 7 in Tables 2A & 2B.

### Example 9

A quantity of turkey offal was received from the plant in Springdale, Ark. The turkey offal were ground into smaller pieces having an average maximum dimension of approximately 10 mm. The grinding was performed with standard chopping/grinding equipment. The resultant quantity of ground turkey offal weighed 17.66 pounds.

The ground turkey offal were placed into a reactor. The reactor comprises of a open-top 50 gallon stainless steel vessel having a stainless steel mixer. The reactor has a digital control panel that displays and controls temperature inside the reactor and speed of the mixer. Reaction time, temperature, and pH were monitored during the process. A digestion solution, 734 grams of sodium hydroxide in 0.27 wgt % aqueous solution, was added. The digestion solution was mixed with the ground turkey offal, and reacted with the offal for (2 hours at 98° C. (+/−2° C.) at atmospheric pressure. The pH of the reaction medium was 11.52. Visual inspection indicated tan liquid, and the offal appeared digested.

After the reaction, the mixture of the reaction product and the remaining reactants was cooled to 50° C. using a circulating cooling bath with ethylene glycol. After the cooling, 800 ml of hydrochloric acid in a 10 wgt % aqueous solution were added to neutralize the mixture by reducing its pH to about 7.0.

The reaction products and remaining reactants were filtered through a sand filter to remove insoluble materials. The remaining materials were passed through three consecutive filters; the first filter had a mesh size of 5.0 microns; the second filter had a mesh size of 1.0 micron; and the third filter had a mesh size of 0.2 microns.

After filtering, the remaining material was flowed through a membrane filter having a molecular weight cutoff of a pre-selected number of Daltons. In particular, the pore size was chosen to capture as concentrate peptones having a pre-selected molecular weight of about 1,000 Daltons. The membrane filter separated the flow into a concentrate mixture (the portion which did not pass through the membrane filter) and a permeate mixture (the portion which passed through the membrane filter).

The permeate mixture was removed from the example 9 process.

The concentrate mixture was spray dried using a Niro Atomizer Portable Spray Dryer drying unit to remove remaining water. The spray dried concentrate was a dried peptone concentrate of 2.4 pounds, which was off-white in color.

The dried peptone concentrate of example 9 was placed aside and later combined and mixed with the dried peptone concentrate of example 10. The combined and mixed concentrates are discussed further in example 11.

Results of example 9 are summarized in Tables 2A & 2B.

### Example 10

A second quantity of turkey offal was received from the plant in Springdale, Ark. and processed in essentially the same manner as example 9.

Substantive differences from example 9 consist of the following: a) After the initial grinding, the resultant quantity of ground offal weighed 17.58 pounds. b) The digestion solution contained 735 grams of sodium hydroxide in 0.27 wgt % aqueous solution. c) The ph for the reaction medium was 11.74. d) The spray dried concentrate was a dried peptone concentrate of 3 pounds. As described for example 9, the example 10 dried peptone concentrate was also off-white in color.

The dried peptone concentrate of example 10 was combined and mixed with the dried peptone concentrate of example 9. The combined and mixed concentrates are discussed further in example 11.

Results of example 10 are summarized in Tables 2A & 2B.

### Example 11

The dried peptone concentrates of Example 9 and Example 10 were collectively analyzed as Example 11. The two concentrates were thoroughly mixed by stirring to form the dried peptone concentrate of Example 11.

The dried peptone concentrate of example 11 was off-white in color. Its dry whiteness was L=79.54. Its solubility in water was 0.01915 gm/ml. Its dry flowability was 50-55 degrees without tap.

The whiteness of the dry concentrate was measured with the Hunter Lab colorimeter as described earlier. The solubility in water was measured using the CRC handbook technique described earlier. Finally, the dry flowability was measured with the standard angle of repose technique described earlier.

A chemical analysis of the dry concentrate of Example 11 indicated the following composition of the concentrate: peptones—84%; moisture—2%; fat—6%; ash—8%; total carbohydrate—<0.1%; calcium—1340 ppm; magnesium—96.8 ppm; phosphorus—321 ppm; potassium—515 ppm; other materials—trace amounts which were not measured.

The peptones, moisture, fat, and ash were measured by methods described in Official Methods of Analysis of AOAC International (2002) 17^{th} edition. (peptones—968.06 and 992.15; moisture—925.09 and 926.08; fat—922.06 and 954.02; ash—923.03). Total carbohydrate was measured by methods described in the Composition of Foods—Agriculture Handbook No. 8, US Department of Agriculture, pp 164-165, 1975. Calcium, magnesium, phosphorus, and potassium was measured by methods provided in Example 8.

The dry concentrate was also analyzed using the HPLC size exclusion technique to determine the molecular weight distribution of peptones. The mixture was found to have approximately virtually no peptones exceeding 100,000 Daltons, 25% between 6000 and 100,000 Daltons, 75% between 1000 and 6000 Daltons, and virtually none less than 1000 Daltons. As can be seen, substantially all the peptones of the dry concentrate have a molecular weight of at least 1,000 Daltons. In addition, a predominance the peptones have a molecular weight in the range of 1,000 Daltons to 6,000 Daltons. In particular, about 75% of the peptones have a molecular weight in the range of 1,000 Daltons to 6,000 Daltons.

Results of example 11 are summarized as collective results for Examples 9 & 10 in Tables 2A & 2B.

TABLE 2A

| | Amount | | | Digestion | | | | | |
|---|---|---|---|---|---|---|---|---|---|
| | of Waste | Type | | Solution | | Digestion | Digestion | Digestion | Digestion |
| | Material | of Waste | Hydrolysis | % | ml | Solution | Temp | Time | Pressure |
| Ex. | pounds | Material | Process | NaOH | NaOH | pH | deg C. | hours | psig |
| 1 | 6.0 | Feathers | Alkaline | 0.5 | 460 | 12-13 | 98 | 1 | atmospheric |
| 2 | 9.46 | Feathers | Alkaline | 0.5 | 460 | 12-13 | 98 | 1 | atmospheric |
| 3 | 17.66 | Offal | Alkaline | 0.27 | 734 | 11.52 | 98 | 2 | atmospheric |
| 4 | 17.58 | Offal | Alkaline | 0.27 | 735 | 11.74 | 98 | 2 | atmospheric |

TABLE 2B

| | | Characteristics of Dried Concentrate | | |
|---|---|---|---|---|
| | Peptones In | of Peptones | | |
| | Dry Peptone | | Aqueous | Flowabillty |
| | Concentrate | Whiteness L, a, | Solubility | degrees |
| Ex. | percent | b scale units | g/ml | (without tap) |
| 6 & 7 | 84.2 | L = 60.01 | 0.05 | 50-55 |
| collectively | | (a = −0.59, | | |
| | | b = 9.13) | | |
| 9 & 10 | 87.0 | L = 79.54 | 0.05 | 50-55 |
| collectively | | (a = −1.63, | | |
| | | b = −11.68) | | |

A number of embodiments of the invention have been described. Nevertheless, it will be understood that various modifications may be made without departing from the spirit and scope of the invention. Accordingly, other embodiments are within the scope of the following claims.

We claim:

1. A method for processing a protein-containing material comprising the following step:
contacting reactants and creating a reaction mix for a period of less than six hours;
wherein the reactants comprise an animal-derived protein-containing material and an alkaline material;
wherein at least some of the protein is hydrolyzed into a mixture of peptones;
wherein the mixture of peptones has a molecular weight distribution such that at least a portion of the peptones have no more than three amino acid mers.

2. The method described in claim 1 wherein the protein-containing material comprises feathers.

3. The method described in claim 2, wherein the feathers comprise poultry feathers.

4. The method described in claim 3, wherein the poultry feathers comprise turkey feathers.

5. The method described in claim 1 wherein the alkaline material comprises sodium hydroxide.

6. The method described in claim 1, wherein the pH of the reaction mix is 8 or higher.

7. The method described in claim 1, wherein the temperature of the reaction mix is above 90 deg C.

8. The method described in claim 2, wherein the feathers comprise poultry offal.

9. A method for processing a protein-containing material comprising the following step:
contacting reactants and creating a reaction mix for a period of less than six hours;
wherein the reactants comprise turkey feathers and sodium hydroxide;
wherein the temperature of the reaction mix is above 90 deg C.;
wherein at least some of the turkey feather is hydrolyzed into a mixture of peptones;
wherein the mixture of peptones has a molecular weight distribution such that at least a portion of the peptones have no more than three amino acid mers.

10. A method for making peptones comprising the following step:
contacting reactants and creating a reaction mix for a period of less than six hours;
wherein the reactants comprise an animal-derived protein-containing material and an alkaline material;
wherein at least some of the protein is hydrolyzed into a mixture of peptones;
wherein the mixture of peptones has a molecular weight distribution such that at least a portion of the peptones have no more than three amino acid mers.

11. The method described in claim 10, wherein the protein-containing material comprises feathers.

12. The method described in claim 11, wherein the feathers comprise poultry feathers.

13. The method described in claim 12, wherein the poultry feathers comprise turkey feathers.

14. The method described in claim 10 wherein the alkaline material comprises sodium hydroxide.

15. The method described in claim 10, wherein the pH of the reaction mix is 8 or higher.

16. The method described in claim 10, wherein the temperature of the reaction mix is above 90 deg C.

17. The method described in claim 10, wherein the protein-containing material comprises offal.

18. A method for making peptones comprising the following step:
contacting reactants and creating a reaction mix for a period of less than six hours;
wherein the reactants comprise turkey feathers and sodium hydroxide;
wherein the temperature of the reaction mix is above 90 deg C.;
wherein at least some of the turkey feather is hydrolyzed into a mixture of peptones;
wherein the mixture of peptones has a molecular weight distribution such that at least a portion of the peptones have no more than three amino acid mers.

19. A method for processing a protein-containing material comprising the following step:
contacting reactants and creating a reaction mix for a period of less than six hours;
wherein the reactants comprise an animal-derived protein-containing material and an alkaline material;
wherein at least some of the protein is hydrolyzed into a mixture of peptones;
wherein the mixture of peptones has a solubility in water of at least 0.01915 gm/ml.

20. A method for processing a protein-containing material comprising the following steps:
contacting reactants and creating a reaction mix;
wherein the reactants comprise an animal-derived protein-containing material and an alkaline material;
wherein at least some of the protein is hydrolyzed into a mixture of peptones;
separating at least some of the peptones by molecular weight;
drying the separated peptones;
wherein the dried peptones have a dry whiteness of L exceeding 75.

21. The mixture of peptones resulting from the method described by claim 1.

22. The mixture of peptones resulting from the method described by claim 9.

23. The peptones made by the method described by claim 10.

24. The peptones made by the method described by claim 18.

25. A method for processing poultry waste material comprising the following steps:
contacting reactants and creating a reaction mix for less than six hours, wherein the reactants comprise a turkey waste material and an alkaline material, and wherein a reaction product is obtained which comprises peptones; and
separating the reaction product to obtain a mixture of peptones for which substantially all of the peptones have a molecular weight of at least about 1,000 Daltons.

26. The method of claim 25, wherein the poultry waste material is selected from the group consisting of feathers, offal, and combinations thereof.

27. The method of claim 25 wherein the poultry waste material is feathers.

28. The method of claim 25, wherein the poultry waste material is offal.

29. The method of claim 25, wherein there is an additional step of separating the reaction product by filtration.

30. The method of claim 29, wherein the filtration comprises:
passing the reaction product through a membrane filter having a pore size ranging from about 10 Angstroms to about 50 Angstroms resulting in a permeate and a concentrate.

31. The method of claim 29, wherein the filtration comprises:
passing the reaction product through a filter having a pore size ranging from about 0.2 microns to about 5 microns; and subsequently
passing the remaining reaction product through a membrane filter having a pore size ranging from about 10 Angstroms to about 50 Angstroms.

32. The method of claim 30, wherein the mixture of peptones in the concentrate has a molecular weight distribution for which at least about 75% of the peptones have a molecular weight between about 1,000 Daltons and about 6,000 Daltons.

33. The method of claim 25, wherein the mixture of peptones has a solubility in water of at least about 0.05 gm/ml.

34. The method of claim 25, wherein the pH of the reaction mix is about 8 or higher.

35. The method of claim 25, wherein the temperature of the reaction mix is above about 90 degrees C.

36. The method of claim 25, wherein during the purifying of the reaction product, an additional mixture of peptones is obtained for which substantially all of the peptones have a molecular weight of less than about 1,000 Daltons.

37. A mixture of peptones resulting from a method for processing turkey waste material which comprises the following steps:
contacting reactants and creating a reaction mix for less than six hours, wherein the reactants comprise the turkey waste material and an alkaline material, and wherein a reaction product is obtained which comprises peptones; and
separating the reaction product to obtain a mixture of peptones for which substantially all of the peptones have a molecular weight of at least about 1,000 Daltons.

38. A peptone concentrate resulting from a method for processing turkey waste material which comprises the following steps:
providing a quantity of turkey waste material;
mechanically breaking the turkey waste material into smaller pieces;
contacting the resultant turkey waste material pieces with an alkaline solution to produce a reaction mix, wherein the temperature of the reaction mix is above about 90 deg C.;
holding the turkey waste material pieces in the reaction mix for a period of time sufficient to produce peptones, wherein a predominance of the peptones have a molecular weight less than about a predetermined number of Daltons;
cooling the reaction mix;
neutralizing the reaction mix;
pre-filtering the reaction mix to remove large impurities;
filtering the remaining reaction mix to obtain a peptone concentrate for which substantially all of the peptones have a molecular weight of at least about 1,000 Daltons;
spray drying the peptone concentrate; and
collecting the peptone concentrate.

39. An ingredient for use in pet foods comprising, a peptone concentrate produced by the method of claim 38.

40. A fertilizer comprising, a peptone concentrate produced by the method of claim 38.

41. The fertilizer of claim 40, wherein the alkaline solution is potassium hydroxide and the reaction mix is neutralized with phosphoric acid.
